(19) United States
(12) Patent Application Publication
(10) Pub. No.: US 2008/0284913 A1
(43) Pub. Date: Nov. 20, 2008

(54) AUDIO-VISUAL SYSTEM, REPRODUCING APPARATUS, AND DISPLAY DEVICE

(75) Inventors: Masazumi Yamada, Osaka (JP); Mitsuhiko Tokuda, Nara (JP); Takashi Ohtsu, Kyoto (JP); Masafumi Shimotashiro, Osaka (JP)

Correspondence Address: RATNERPRESTIA, P.O. BOX 980, VALLEY FORGE, PA, 19482, US

(73) Assignee: Matsushita Electric Industrial Co., Ltd., Osaka (JP)

(21) Appl. No.: 12/121,867

(22) Filed: May 16, 2008

(30) Foreign Application Priority Data
May 17, 2007 (JP) 2007-131176

(51) Int. Cl. H04N 5/445

(52) U.S. Cl. 348/563; 348/E05.099

(57) ABSTRACT

The TV receiver as a display device has a drawing generation unit for generating display side drawing data of drawn picture according to a display format for on-screen display, and a reproducing apparatus has a drawing generation unit for generating reproduction side drawing data of drawn picture according to a display format for display on the TV receiver. The drawing generation unit receives the display format information of the drawing generation unit through a connection cable, and generates reproduction side drawing data of display format based on the received display side display format information. The reproducing apparatus supplies the contents data including the generated reproduction side drawing data to the TV receiver through the connection cable, and the TV receiver presents the drawn picture based on the supplied reproduction side drawing data.

### FIELD OF THE INVENTION

The present invention relates to an audio-visual system, a reproducing apparatus, and a display device composed of a display device having a video display function such as television receiver, and an external device such as recording and reproducing apparatus to be connected thereto, and more particularly to an audio-visual system, a reproducing apparatus, and a display device capable of operating an external device by using only a remote control device of a display device.

### BACKGROUND OF THE INVENTION

In a recent progress in multimedia related technology, there is a rapid progress in the technology about apparatus and method of processing digital data compressed and coded from contents data. In particular, the capacity is increasing in recording media, such as hard disk, optical disk, or memory card, and in the field of consumer video appliances for recording video signals and audio signal, it is general to record and handle digital data of large quantity such as video data. Accordingly, various AV (audio-visual) appliances are presented such as DVD decoder and other recording and reproducing apparatuses, and various devices for handling video data and audio data are available.

On the other hand, along with increase in the variety of AV appliances, television (or TV) receivers are also demanded to be provided with digital interface terminals known as multimedia interface in addition to the conventional analog video input terminals. For this purpose, technologies are proposed about constitution of audio-visual system for connecting data between TV receiver and external AV appliance through communication means. One of technologies about such audio-visual systems is the technology of transferring the remote-control signal sent out to the TV receiver to the AV appliance side via communication means, and allowing the AV appliance to execute the process according to the remote-control signal. Such technology is disclosed, for example, Unexamined Japanese Patent Application No. 2006-333101.

FIG. 9 is a block diagram of a conventional TV information display system for connecting data between a TV receiver and an information processing device through communication means as disclosed in Unexamined Japanese Patent Application No. 2006-333101. In FIG. 9, TV receiver 92 and information processing device 93 are connected by way of information communication line 94.

TV receiver 92 displays the image of TV broadcast received in broadcast receiving unit 926 in a display screen of information display unit 925. TV receiver 92 makes use of the function of Picture-In-Picture (picture in picture) provided in TV receiver 92, or changes over the input completely to the input from information processing device 93, and displays the picture information entered from information processing device 93 in part of the image on the display screen. Remote-control unit 97 receives a remote-control code corresponding to the user's operation of the remote controller operated by the user. Information communication unit 927 communicates with information processing device 93 through information communication line 94. Information processing device 93 is an apparatus for collecting information by way of a network such as the Internet by means of information collection unit 931. Video generation unit 932 generates video information on the basis of the information collected by information collection unit 931. Video output unit 933 produces the video information generated by video generation unit 932 as picture information, and issues to information display unit 925 of TV receiver 92 by way of information communication line 94. Information communication unit 934 communicates with TV receiver 92 by way of information communication line 94.

The conventional TV information displays system having such configuration operates as follows. First, TV receiver 92 notices TV operation information and internal setting information including the channel code information being viewed at the present, to information processing device 93 through information processing line 94. Information processing device 93 receives the TV operation information and internal setting information, and searches for channel program and others, and acquires the related information. Information processing device 93 generates the picture information of the related program on the basis of the related information in its video generation unit 932. Information processing device 93 also generates the display position and size information on the basis of the own collected information depending on the type of the picture information to be issued. The picture information generated in video generation unit 932 is supplied from video output unit 933 to information display unit 925 through information communication line 94. The display position and size information generated in information processing device 93 are noticed to information communication unit 927 by way of information communication wire 94. In this manner, the image combining the pictures of the picture information supplied from information processing device 93 is displayed on the display screen of information display unit 925. That is, in the conventional TV information display system, information processing device 93 generates the picture information of the contents on the basis of the user's operation of the remote controller and the internal setting information of TV receiver 92, and this picture information is displayed as sub-screen in part of the display screen of TV receiver 92. Thus, according to the conventional TV information system, the image of TV broadcast and the personally required picture can be displayed simultaneously without any extra effort in operation.

In the case of the conventional TV information system as disclosed in Unexamined Japanese Patent Application No. 2006-333101, however, the content of the sub-screen displaying the picture information is the content based on the TV operation information or internal setting information. But the information relating to the position, shape or size for displaying the sub-screen is instructed to TV receiver 92 side on the basis of the own information collected by information processing device 93. Accordingly, in TV receiver 92, when changed over from the original Picture-In-Picture function under the control of TV receiver 92 to the picture information display function, for example, the position and size of the sub-screen by the original Picture-In-Picture function are changed to the position and size controlled from information processing device 93. In a more specific example, when changed from the state of display of different channel images in the main screen and sub-screen by the own function of TV receiver 92, to the display of the picture information in the sub-screen by information processing device 93, the position and size of the sub-screen are also changed. Such change in the position and size of sub-screen may feel strange for the user or may urge the user to change the position and size to the original image, and the user's labor may be increased.

In particular, when attempted to build up an audio-visual system for on-screen display of menu screen used in the user interface in the TV receiver, if composed on the basis of the technique in Unexamined Japanese Patent Application No. 2006-333101, when the TV receiver and the external device are changed over, the menu screen by the TV receiver and the menu screen by the external device may displayed in different position, shape or size at high possibility. That is, the TV receiver and the external device set the position, shape or size of menu screen independently. As a result, the menu screen corresponding to the TV receiver and the menu screen corresponding to the external device may be displayed differently. Such mutually different menu screens may feel strange for the user. For example, if the user sets to increase the display of the menu screen of the TV receiver, a small size may be displayed when the menu screen of the external device is called, and the convenience of manipulation for the user is lowered.

### SUMMARY OF THE INVENTION

The present invention is devised to solve these problems, and it is hence an object thereof to present an audio-visual system, a reproducing apparatus, and a display device enhanced in the convenience of manipulation for the user, in an audio-visual system connecting data between a display device and a reproducing apparatus.

The audio-visual system is an audio-visual system includes a display device for on-screen display of drawn picture in a specified display format, a reproducing apparatus for supplying data including the contents data to be reproduced to the display device, being connected by way of communication means, in which the display device has a display side drawing generation unit for generating display side drawing data of drawn picture according to the display format of on-screen display, the reproducing apparatus has a reproduction side drawing generation unit for generating reproduction side drawing data of drawn picture according to the display format for displaying on the display device, the reproduction side drawing generation unit receives the display side display format information as the information of the display format of the display side drawing generation unit by way of communication means, and generates the reproduction side drawing data based on the received display format information of the display side, the reproducing apparatus supplies the contents data including the generated reproduction side drawing data to the display device by way of communication means, and the display device presents the drawn picture based on the supplied reproduction side drawing data.

The reproducing apparatus is a reproducing apparatus connected to the display device for on-screen display of drawn picture in specified display format, for supplying data including contents data to be reproduced to the display device, and includes a reproduction side drawing generation unit for receiving display side display format information as information of the display format of the display device, and generating reproduction side drawing data of the display format on the basis of the received display side display format information, and a data supply unit for supplying the reproduction side drawing data to the display device together with contents data.

The display device is a display device connected to the reproducing apparatus for supplying the data including contents data to be reproduced, for on-screen display of drawn picture in specified display format, and includes a display side drawing generation unit for receiving reproduction side display format information as the information of the display format of drawn picture of the reproducing apparatus, and generating display side drawing data of the display format on the basis of the received reproduction side display format information.

### BRIEF DESCRIPTION OF THE DRAWINGS

FIG. 1 is a block diagram of configuration of audio-visual system, reproducing apparatus and display device in a preferred embodiment of the present invention.

FIG. 2A is a diagram showing an example of menu screen of audio-visual system, reproducing apparatus and display device in a preferred embodiment of the present invention.

FIG. 2B is a diagram showing an example of menu screen of audio-visual system, reproducing apparatus and display device in a preferred embodiment of the present invention.

FIG. 3 is a flowchart showing a processing procedure of remote-control process to be executed by a control unit of a TV receiver in audio-visual system, reproducing apparatus and display device in a preferred embodiment of the present invention.

FIG. 4 is a flowchart showing a processing procedure of menu process to be executed by a control unit of a reproducing apparatus in audio-visual system, reproducing apparatus and display device in a preferred embodiment of the present invention.

FIG. 5 is a diagram showing an example of display according to a display format relating to a position of menu screen.

FIG. 6 is a diagram showing an example of display according to a display format relating to a size of menu screen.

FIG. 7 is a diagram showing an example of display according to a display format relating to a character size of menu screen.

FIG. 8 is a diagram showing an example of display according to a display format relating to display content of menu screen.

FIG. 9 is a block diagram of a conventional TV information display system.

### DETAILED DESCRIPTION OF PREFERRED EMBODIMENTS

Preferred embodiments of the present invention are described specifically below while referring to the accompanying drawings.

### Preferred Embodiments

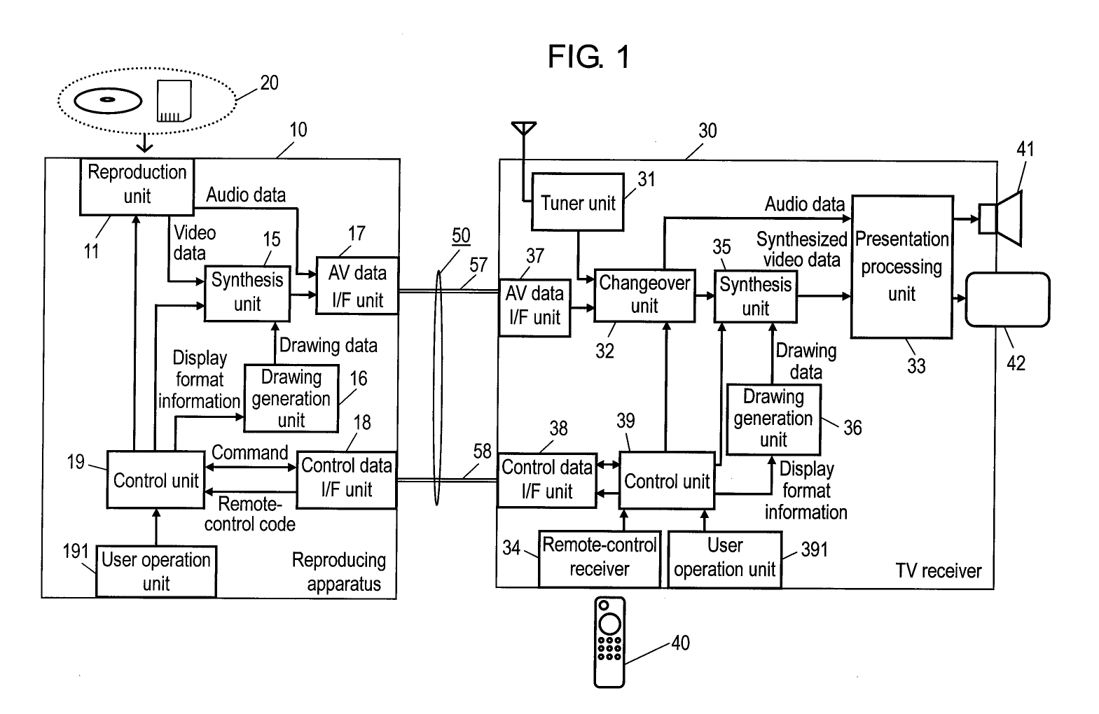

FIG. 1 is a block diagram of configuration of audio-visual system, reproducing apparatus and display device in a preferred embodiment of the present invention.

As shown in FIG. 1, the audio-visual system of the preferred embodiment includes TV receiver 30, reproducing apparatus 10, and connection cable 50. TV receiver 30 presents the received TV broadcast video and audio to the user. Reproducing apparatus 10 reproduces recording medium 20 such as DVD and memory card, and issues as video signal or audio signal. Connection cable 50 connects between TV receiver 30 and reproducing apparatus 10. In the preferred embodiment, a display device for on-screen display of drawn picture for user interface or the like in a specified display format is designated as TV receiver 30, a reproducing apparatus for supplying the data containing the contents data to be reproduced to TV receiver 30 is designated as reproducing apparatus 10, and communication means is designated as connection cable 50.

In the preferred embodiment, TV receiver 30 has a digital external input terminal, and the video signal and audio signal reproduced by reproducing apparatus 10 are supplied into the digital external input terminal by way of AV cable 57 included in connection cable 50 as contents data of digital signal. The digital interface for digital connection between AV appliances includes HDMI (high definition multimedia interface) standard. In the preferred embodiment, TV receiver 30 has a digital external input terminal, but it may also have an analog external input terminal.

Reproducing apparatus 10 shown in FIG. 1 includes user operation unit 191, control unit 19, reproduction unit 11, drawing generation unit 16, synthesis unit 15, AV data interface unit (AV data I/F unit) 17, and control data interface unit (control data I/F unit) 18. Synthesis unit 15 and AV data I/F unit 17 are collectively called a data supply unit. As the detail is described below, the data supply unit consisting of synthesis unit 15 and AV data I/F unit 17 functions to supply the reproduction side drawing data to the display device together with contents data. User operation unit 191 receives user's operations. Control unit 19 controls the entire apparatus, and holds various pieces of information. Reproduction unit 11 reproduces recording medium 20, and issues video data and audio data. Drawing generation unit 16 is an example of configuration of reproduction side drawing generation unit for generating reproduction side drawing data. Synthesis unit 15 synthesizes the video data and drawing data, and issues synthesized video data. AV data I/F unit 17 issues the synthesized video data or audio data externally as contents data. Control data I/F unit 18 communicates with a partner side appliance by means of command or other control data.

In FIG. 1, user operation unit 191 is an operation unit installed in the apparatus, and receives instructions about operation of reproducing apparatus 10 by user's operations. User operation unit 191 notices the instruction information corresponding to the received instructions to control unit 19. Control unit 19 receives the instruction information from user operation unit 191, and analyzes the instruction information, and controls the corresponding parts in the apparatus according to the instruction information.

Control unit 19 receives control data including commands and others from control data I/F unit 18, and control unit 19 also sends control data including commands and others to control data I/F unit 18. That is, as shown in FIG. 1, control data I/F unit 18 is connected to TV receiver 30 by way of control cable 58 included in connection cable 50. As a result, from TV receiver 30 to control data I/F unit 18, various commands and information are noticed for the purpose of controlling reproducing apparatus 10. Control data I/F unit 18 notices the received control data to control unit 19, and control unit 19 executes the process according to the command contained in the received control data. To the contrary, the control data on TV receiver 30 generated by control unit 19 is sent out from control unit 19 to TV receiver 30 in a specified format by way of control data I/F unit 18 and control cable 58. In this audio-visual system, in particular, a specified remote-control code from remote controller 40 received in TV receiver 30 is also noticed to control unit 19 by way of control cable 58 and control data I/F unit 18. In this audio-visual system, such specified remote-control code is noticed from TV receiver 30 to reproducing apparatus 10 in specified format.

Reproduction unit 11 reproduces recording medium 20 loaded in reproducing apparatus 10 according to the instruction from control unit 19. The audio data reproduced in reproduction unit 11 is supplied to AV data I/F unit 17, and the video data is supplied to synthesis unit 15. In the preferred embodiment, an example of reproducing apparatus 10 having only a function of reproduction of recording medium 20 is shown. Of course, reproducing apparatus 10 may also have a function of recording contents data in recording medium 20. It may be also realized by a video camera device or digital camera device having an imaging function. The apparatus may be also a personal computer or TV game device for generating contents data. It may be also a tuner device or a set-top box device having only TV broadcast receiving function. Further, it may be an audio appliance for reproducing or generating audio data only.

Drawing generation unit 16 generates reproduction side drawing data (or merely drawing data) corresponding to the drawn picture for on-screen display on the image reproduced by reproduction unit 11. Such drawn picture includes, for example, a menu screen for user interface, an electronic program guide (EPG) screen for presenting a list of programs, and an operation guide screen for presenting a list of operations. Drawing generation unit 16 generates drawing data according to the instruction from control unit 19. Drawing generation unit 16 also receives reproduction side display format information from control unit 19, and displays the drawn picture on screen in the display format conforming to the display format information. Such display format information is information about display format of on-screen display of drawn picture, and is information including display position of drawn picture, size and shape of drawn picture, character size in drawn picture, and display contents type in drawn picture. Thus, drawing generation unit 16 is a reproduction side drawing generation unit, and generates the drawing data of drawn picture according to the display format of on-screen display.

Synthesis unit 15 receives a synthesis instruction from control unit 19, and synthesizes the video data from reproduction unit 11 and the drawing data from drawing generation unit 16 according to display format information, and issues synthesized video data for on-screen display of drawn picture on the video. Synthesis unit 15, if instruction of synthesis from control unit 19 is not noticed, issues the video data from reproduction unit 11 as synthesized video data. When reproducing apparatus 10 reproduces only the audio data, when instruction of synthesis is noticed from control unit 19, the synthesized video data of drawing data only not containing video data is issued.

AV data I/F unit 17 externally issues the synthesized video data from synthesis unit 15 and the audio data from reproduction unit 11 as contents data. As shown in FIG. 1, AV data I/F unit 17 is connected to TV receiver 30 by way of AV cable 57 included in connection cable 50. As a result, the contents data is sent out from the AV data I/F unit 17 to TV receiver 30.

TV receiver 30 shown in FIG. 1 includes user operation unit 391, remote-control receiver 34, control unit 39, control data I/F unit 38, AV data I/F unit 37, tuner unit 31, changeover unit 32, drawing generation unit 36, synthesis unit 35, presentation processing unit 33, speaker 41, and display 42. User operation unit 391 receives user's operations. Remote-control receiver 34 receives user's operations from remote controller 40. Control unit 39 controls the entire receiver, and holds various pieces of information. Control data I/F unit 38 communicates with a partner side appliance by way of command and other control data. AV data I/F unit 37 receives and takes in the contents data supplied from outside. Tuner unit 31 receives TV broadcast, and restores the contents data of TV broadcast. Changeover unit 32 changes over the contents data of tuner unit 31 and AV data I/F unit 37 according to an instruction from control unit 39, and issues as video data and audio data. Drawing generation unit 36 is an example of display side drawing generation unit for generating display side drawing data. Synthesis unit 35 synthesizes the video data and drawing data, and issues synthesized video data. Presentation processing unit 33 converts the audio data and synthesized video data into audible and visible signals. Speaker 41 produces sound, and display 42 display video. In the preferred embodiment, an example of TV receiver 30 having tuner unit 31 is shown, but it may be also realized by a display device having at least a video presentation function, not having broadcast receiving function such as tuner unit 31.

In FIG. 1, user operation unit 391 is an operation unit installed in the main body of TV receiver 30, and receives an instruction about operation of TV receiver 30 by user's operations. User operation unit 391 notices the instruction information corresponding to the received instruction to control unit 39. Remote-control receiver 34 receives an instruction about operation of TV receiver 30 according to the user's manipulation of remote controller 40. That is, when the user manipulates remote controller 40, remote controller 40 sends out a remote-control signal showing a remote-control code corresponding to the manipulation. Remote-control receiver 34 receives such remote-control signal, and notices the remote-control code indicated by the remote-control signal to control unit 39 as instruction information.

Remote controller 40 has mode keys such as “Select channel”, “Change input”, “Show menu”, and “Close menu”, and menu screen manipulation keys such as “Up”, “Down”, “Right”, “Left”, “Fix”, and “Return”. The user presses these keys, and remote-control codes corresponding to the keys are noticed to control unit 39.

Control unit 39 receives instruction information from user operation unit 391, and remote-control code as instruction information from remote-control receiver 34, and analyzes the instruction information, and controls the parts of the receiver according to the instruction information.

Control unit 39 also receives control data including commands from control data I/F unit 38 in specified format, and control unit 39 notices the control data including commands to control data I/F unit 38. That is, as shown in FIG. 1, control data I/F unit 38 is connected to reproducing apparatus 10 by way of control cable 58 included in connection cable 50. As a result, from control data I/F unit 38 to reproducing apparatus 10, various commands and information are noticed for controlling reproducing apparatus 10. Thus, control unit 39 controls the parts in the receiver, and when judging it necessary to control at reproducing apparatus 10 side as a result of analysis of instruction information such as remote-control code, it sends out the control data to reproducing apparatus 10 by way of control data I/F unit 38 and control cable 58. To the contrary, control data I/F unit 38 receives control data from reproducing apparatus 10, and notices to control unit 39.

In particular, in this audio-visual system, a specified remote-control code received from remote controller 40 is also noticed to reproducing apparatus 10 in specified format by way of control data I/F unit 38 and control cable 58. That is, control unit 39 analyzes the remote-control code noticed from remote-control receiver 34, and when this remote-control code is specified to be a remote-control code to reproducing apparatus 10, this remote-control code is sent out to reproducing apparatus 10 by way of control data I/F unit 38 control cable 58. In reproducing apparatus 10, when control unit 19 receives such remote-control code from control unit 39, processing or control corresponding to such remote-control code is executed.

In this manner, in the audio-visual system, TV receiver 30 has a function of judging whether the received remote-control signal is a remote-control signal corresponding to operation of TV receiver 30 or reproducing apparatus 10. When TV receiver 30 judges that the remote-control signal is for reproducing apparatus 10, it notices the instruction information of the received remote-control signal, including, for example, the instruction information as generation instruction of drawing data to drawing generation unit 16 to reproducing apparatus 10 by way of connection cable 50. Reproducing apparatus 10 executes the process according to the instruction information noticed through connection cable 50. The audio-visual system has such configuration, by manipulation of only one remote controller 40 toward TV receiver 30, setting of operation and data on TV receiver 30 and reproducing apparatus 10 can be easily realized.

Changeover unit 32 changes over the contents data of the tuner unit 31 and AV data I/F unit 37 depending on the instruction from control unit 39. Further, changeover unit 32 issues the changed and selected contents data as video data and audio data. That is, when the user presses the “Change input” key on remote controller 40, remote controller 40 sends out a remote-control signal of the remote-control coded corresponding to the manipulation of input changeover. This remote-control code is noticed to control unit 39 by way of remote-control receiver 34. Control unit 39 judges that the noticed remote-control code is an instruction for input changeover, and controls to change over the selection of contents data by changeover unit 32.

Drawing generation unit 36 generates display side drawing data (or merely drawing data) corresponding to drawn picture for on-screen display on the image displayed in display 42. Such drawn picture includes, for example, a menu screen for user interface, an electronic program guide (EPG) screen for presenting a list of programs, a contends guide screen, and an operation guide screen for presenting a list of operations. Drawing generation unit 36 generates drawing data according to the instruction from control unit 39. Drawing generation unit 36 also receives display side display format information from control unit 39, and displays the drawn picture on screen in the display format according to the display format information. Such display format information is information about display format of on-screen display of drawn picture, and is information including display position of drawn picture, size and shape of drawn picture, character size in drawn picture, and display contents type in drawn picture. Thus, drawing generation unit 36 is a display side drawing generation unit, and generates the drawing data of drawn picture according to the display format of on-screen display.

Synthesis unit 35 receives a synthesis instruction from the control unit 39, and synthesizes the video data from changeover unit 32 and the drawing data from drawing generation unit 36 according to display format information, and issues synthesized video data so that the drawn picture may be displayed on screen on the image. When synthesis instruction is not noticed from control unit 39, synthesis unit 35 issues the video data from changeover unit 32 as synthesized video data.

Presentation processing unit 33 converts the audio data from changeover unit 32 and the synthesized video data from synthesis unit 35 into audible and visible signals, and supplies to speaker 41 and display 42. Speaker 41 produces the sound corresponding to the audio data, and display 42 shows the video corresponding to the synthesized video data.

Further, in the audio-visual system, for example, when changeover unit 32 changes over the selection of contents data by instruction from control unit 39, and control unit 39 executes processing of transmission and reception of display format information depending on the changeover direction. That is, when control unit 39 instructs selection of contents data of tuner unit 31 side to changeover unit 32, control unit 39 executes data communication with control unit 19 by way of control cable 58 as follows. First, control unit 39 instructs control unit 19 to send out display format information of reproducing apparatus 10 side. In response, control unit 19 sends out the display format information of reproducing apparatus 10 side to control unit 39. Control unit 39 receives the display format information from control unit 19, and saves the received display format information as a new display format information to drawing generation unit 36. To the contrary, when control unit 39 instructs changeover unit 32 to select the contents data of AV data I/F unit 37 side, control unit 39 executes data communication with control unit 19 by way of control cable 58 as follows. First, control unit 39 instructs control unit 19 to send out display format information of TV receiver 30 side. In response, control unit 19 receives the sent display format information, and saves the received display format information as a new display format information to drawing generation unit 16.

Thus, in this audio-visual system, for example, depending on changeover of changeover unit 32, exchange of final display format information is executed between TV receiver 30 and reproducing apparatus 10. That is, reproduction side drawing generation unit 16 receives the display format information of display side drawing generation unit 36 through connection cable 50, and generates the reproduction side drawing data in display format conforming to the received display side display format information. Thus, reproducing apparatus 10 supplies the contents data including the generated reproduction side drawing data to TV receiver 30 through connection cable 50, and TV receiver 30 presents the drawn picture based on the supplied reproduction side drawing data. To the contrary, display side drawing generation unit 36 receives the display format information of reproduction side drawing generation unit 16 through connection cable 50, and generates the display side drawing data in display format conforming to the received reproduction side display format information. Thus, TV receiver 30 presents the drawn picture based on the generated display side drawing data.

This is the explanation about exchange of display format information when changing over by selection of changeover unit 32. But not limited to such time of changing over, for example, the operation may also include processing means for exchanging display format information on the following timing. That is, in other process, when started by turning on the power source of reproducing apparatus 10 side, control unit 39 of TV receiver 30 takes in the display format information held in control unit 39 of TV receiver 39 side. In other process, when control unit 39 of TV receiver 30 side detects reproducing apparatus 10 connected to the digital external input terminal, control unit 39 sends out display format information to control unit 19 at reproducing apparatus 10 side. In another process, a specific period is provided, and in every specific period regularly, control unit 19 of reproducing apparatus 10 side receives the display format information held in control unit 39 of TV receiver 30 side. Alternatively, in every specific period, control unit 39 of TV receiver 30 side sends out the display format information to control unit 19 of reproducing apparatus 10 side. Or, control unit 39 of TV receiver 30 side detects the change in contents, receiving channel or user setting on menu screen, and at the detected timing, control unit 39 sends out display format information to control unit 19 of reproducing apparatus 10 side. The audio-visual system may include part or all of such processing means.

As the detail is described specifically below, the audio-visual system includes, in addition to such function of executing exchange of display format information, a function of setting such display format information by making use of remote controller 40 and the menu screen as one of drawn pictures. Hence, the display format of drawn pictures may not be set in each device, but the drawn picture of each device may be displayed while maintaining the desired display format for the user.

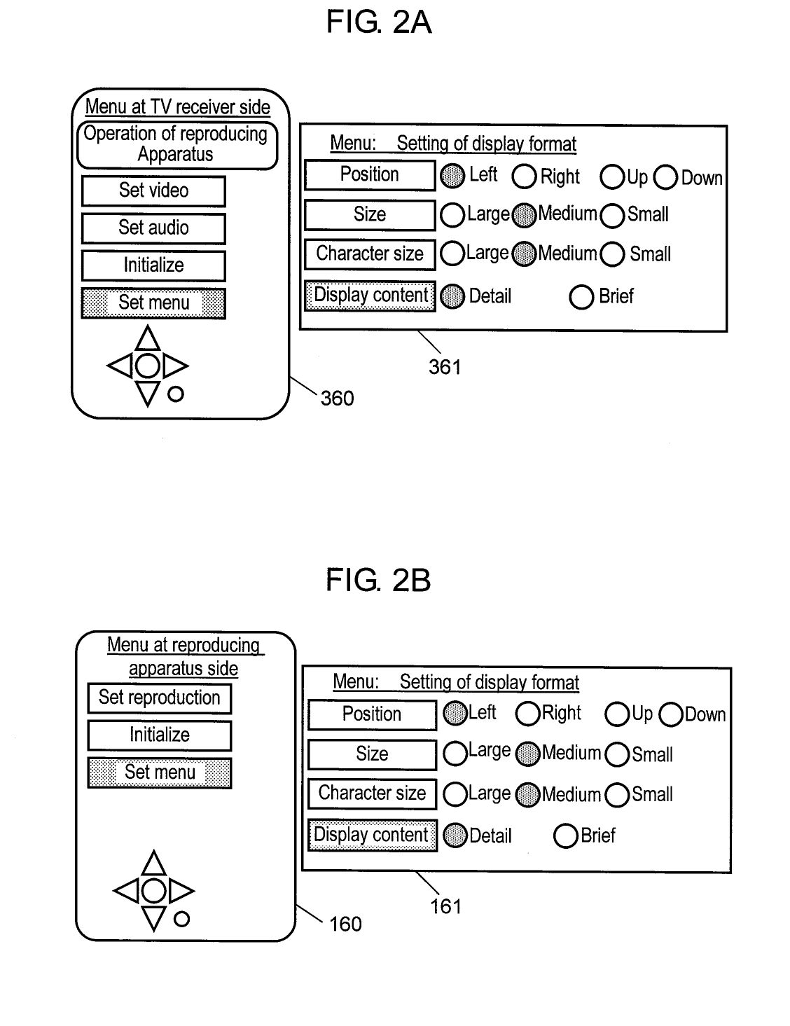

As one of the drawn pictures, the menu screen is described below. FIG. 2A and FIG. 2B are diagrams showing examples of menu screens of audio-visual system, reproducing apparatus, and display device in the preferred embodiment. FIG. 2A shows an example of menu screen generated in drawing generation unit 36 of TV receiver 30. FIG. 2B shows an example of menu screen generated in drawing generation unit 16 of reproducing apparatus 10. In FIG. 2A and FIG. 2B, the menu screen consists of a main menu screen called from remote controller 40, and a sub menu screen displayed depending on the selection operation of the main menu screen. The main menu screen includes a plurality of selection buttons for selecting principal functions of the corresponding devices. When the user selects a desired function from the plural selection buttons, a sub menu screen corresponding to the function is displayed. FIG. 2A shows main menu screen 360 and sub menu screen 361 corresponding to TV receiver 30, and FIG. 2B shows main menu screen 160 and sub menu screen 161 corresponding to reproducing apparatus 10.

In the audio-visual system, for example, a “Show TV menu” key on remote controller 40 is pressed or other instruction for displaying the menu screen is operated, first, as shown in FIG. 2A, main menu screen 360 relating to operation of TV receiver 30 is displayed on screen. In this example, main menu screen 360 displays operation buttons for “Set video”, “Set audio”, “Initialize”, and “Set menu” as operation corresponding to TV receiver 30. Further in FIG. 2A, the display also includes a selection button for “Operate reproducing apparatus” for calling and displaying main menu screen 160 corresponding to reproducing apparatus 10 shown in FIG. 2B. The user pushes the “Up” or “Down” key for instructing up or down move of remote controller 40, and selects the selection button of desired function. In FIG. 2A, by such operation, the selection button of “Set menu” is selected. When the user presses “Fix” key for making decision in remote controller 40, sub menu screen 361 for menu setting is displayed. In FIG. 2A, as sub menu screen 361 for set menu, an example of screen for presenting function of changing the display format of menu screen according to the preference of the user is shown. The user further manipulates the move key or the like of remote controller 40, and selects a button on sub menu screen 361, and sets a desired function. For example, when the user manipulates to select Position and Left on sub menu screen 361, and presses “Fix” key on remote controller 40, control unit 39 judges that on-screen display of menu screen at the left side of the display screen has been instructed. Further, control unit 39 saves the information saying “Show to the left”, as the display position information included in the display format information, and notices to drawing generation unit 16. Such process is executed, and thereafter main menu screen 360 sub menu screen 361 shown in FIG. 2A are displayed at the left side of the display screen of display 42. As explained about exchange of display format information between reproducing apparatus 10 and TV receiver 30, it may be configured to notice the display format information by making use of the timing of changing the user setting on the menu screen as explained herein. That is, control unit 39 of TV receiver 30 side first detects that the user setting is changed on the menu screen. On the basis of this detection, control unit 39 sends out the display format information held in control unit 39, or the changed display format information, if the display format information itself has been changed as shown in FIG. 2A, to control unit 19 of reproducing apparatus 10. Thus, the display format information may be noticed to reproducing apparatus 10 side. Or, at the changing timing of the user setting, control unit 39 may notice the change of user setting or display format information to control unit 19 of reproducing apparatus 10 side, and in response control unit 19 may receive and take in the display format information.

Moreover, in the audio-visual system, when the user selects the “Play reproducing apparatus” button shown in FIG. 2A, the screen is changed to the video from reproducing apparatus 10, and main menu screen 160 shown in FIG. 2B is displayed on screen. That is, by selection of the Play reproducing apparatus, from control unit 39 of TV receiver 30 side to control unit 19 of reproducing apparatus 10 side, a command for requesting on-screen display of the menu screen generated by drawing generation unit 16, that is, main menu screen 160 is sent out. In response, control unit 19 controls so that synthesis unit 15 may issue synthesized video data of on-screen display of main menu screen 160. The contents data including the synthesized video data is supplied to TV receiver 30 through AV cable 57, and the video including main menu screen 160 corresponding to such synthesized video data is shown in display 42. Thereafter, by the same operation as in the operation of TV receiver 30, setting on reproducing apparatus 10 is determined. Same as when the user setting is changed by the menu screen at TV receiver 30 side as shown in FIG. 2A, when the user setting is changed on the menu screen at reproducing apparatus 10 side as shown in FIG. 2B, the display format information may be noticed by using this changed timing. That is, control unit 19 of reproducing apparatus 10 side first detects change of user setting on the menu screen. On the basis of this change, control unit 19 sends out the display format information held in control unit 19, or the changed display format information if the display format information has been changed as shown in FIG. 2B, to control unit 39 of TV receiver 30 side. Alternatively, control unit 19 may notice the change of user setting or display format information to control unit 39 at TV receiver 30 side at the change timing of user setting, and in response, control unit 39 may receive and take in the display format information.

Herein, for menu setting, the sub menu screen is used, and the display format of the menu screen is set, but the format may be set by including the EPG screen, operation guide screen, or drawn picture display format. Or the sub menu screen may be displayed for setting the display format depending on the type of the drawn picture.

The audio-visual system, the reproducing apparatus, and the display device of the preferred embodiment may be freely set in the display format of menu screen or drawn picture by using remote controller 40 and the menu screen shown in FIG. 2A and FIG. 2B. Accordingly, the drawn picture according to the preference of the user can be displayed on the image. For example, if the user feels that the character size of menu screen is too small, the character size may be increased, or if the user preferred a detailed display, the character size may be reduced and the detail may be displayed. In this way, the audio-visual system of the preferred embodiment can set the menu screen freely depending on the visual recognition of the user.

In this audio-visual system, for example, when changing over the input, that is, when changing over between the contents data from tuner unit 31 included in TV receiver 30 and the contents data externally entered from reproducing apparatus 10, or when the user setting is changed on the menu screen, the final display format information is noticed and saved between the two control units. Accordingly, the drawn picture of each device can be displayed while maintaining the display format preferred by the user. That is, for example, when the position of the menu screen of TV receiver 30 side is set to the left on sub menu screen 361 shown in FIG. 2A, if the menu screen of reproducing apparatus 10 side shown in FIG. 2B is called, it is displayed at the left side on the display screen. It is hence not necessary to set the display format newly in each device, and the user's labor can be saved.

The audio-visual system, the reproducing apparatus, and the display device of the preferred embodiment have such configuration, and by using only remote controller 40 attached to TV receiver 30, the menu screen of reproducing apparatus 10 can be controlled. Hence the user, without having consciousness of operation of TV receiver 30 or operation of reproducing apparatus 10, can handle only the same remote controller without knowing the external device, and can control reproducing apparatus 10 and other external devices in the same manner. Also in the audio-visual system, the reproducing apparatus, and the display device, the user is allowed to set the menu screen and other display formats freely as desired. Further, in the audio-visual system, the reproducing apparatus, and the display device, the user does not have to set such display format individually in reproducing apparatus 10 and other external devices, and the display format once determined is commonly reflected in TV receiver 30 and external devices. Without requiring complicated operation, the menu screen preferred by the user can be displayed.

In the audio-visual system, the reproducing apparatus, and the display device having such configuration, the operation is specifically described below.

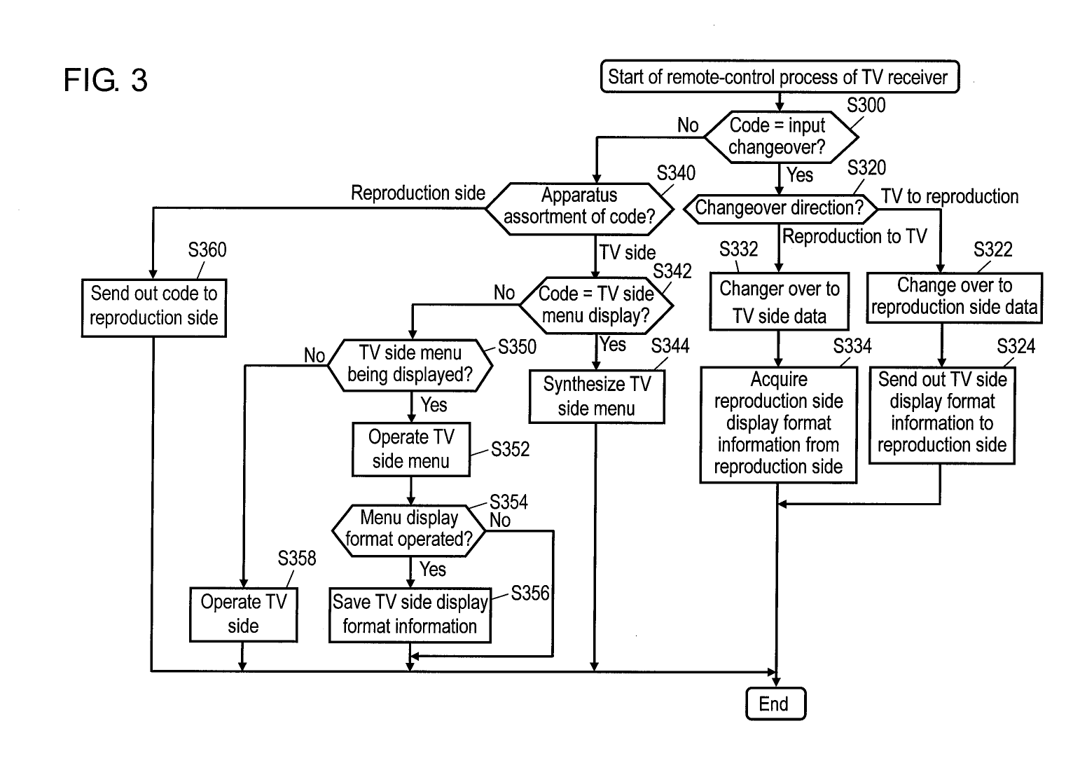

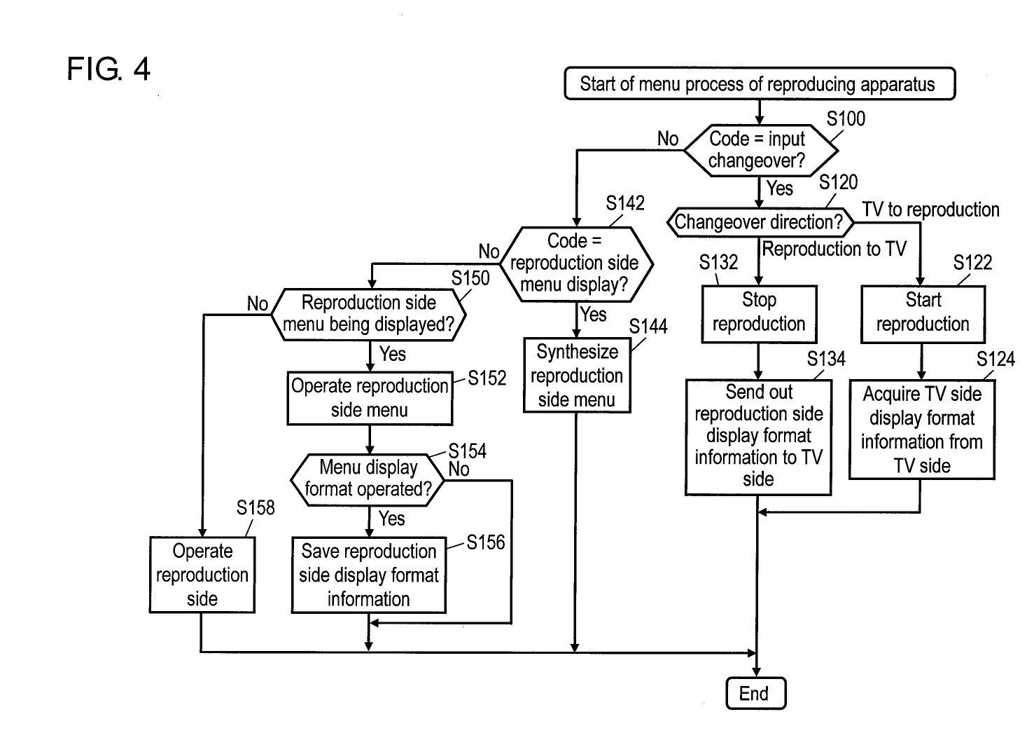

FIG. 3 is a flowchart of processing procedure of remote-control process to be executed by control unit 39 of TV receiver 30 in the audio-visual system, the reproducing apparatus, and the display device of the preferred embodiment. FIG. 4 is a flowchart of processing procedure of menu process to be executed by control unit 19 of reproducing apparatus 10 in the audio-visual system, the reproducing apparatus, and the display device of the preferred embodiment.

Referring now to FIG. 3 and FIG. 4, the remote-control process and menu process of the audio-visual system, the reproducing apparatus, and the display device are explained, mainly about operation of the audio-visual system, the reproducing apparatus, and the display device relating to the display format information as the main feature of the invention. In FIG. 3 and FIG. 4, when changing over the input, an example of notice of display format information of menu screen between reproducing apparatus 10 and TV receiver 30 is explained. For the ease of understanding of the feature of the audio-visual system, the reproducing apparatus, and the display device, in FIG. 3 and FIG. 4, first the remote-control code is judged to be input changeover code or not, and in the case of input changeover code, the display format information is noticed. However, the display format information may be noticed when the user setting is changed, or the procedure may be varied depending on the notice timing of display format information.

In this audio-visual system, when the user manipulates remote controller 40, remote controller 40 sends out a remote-control signal showing the remote-control code depending on the operation to TV receiver 30. The remote-control signal is received in remote-control receiver 34, and the remote-control code of the remote-control signal is noticed to control unit 39. Control unit 39 receives the remote-control code, and starts the process as shown in FIG. 3.

Control unit 39 of TV receiver 30 first judges the entered remote-control code. That is, control unit 39 judges whether the remote-control code is an input changeover code or not, and in the case of an input changeover code, it executes the process including the process of notice of display format information as mentioned above. As shown in FIG. 3, control unit 39 judges the remote-control code, and if judging No (not input changeover code), it advances to process of step S340, and if judging Yes (input changeover code), it advances to process of step 320 (step S300). At step S340, control unit 39 judges whether the remote-control code is a code to TV receiver 30 or a code to reproducing apparatus 10. When control unit 39 judges the code is to TV receiver 30 (TV side), it advances to process of step S342, and if judging to be the code to reproducing apparatus 10 (reproduction side), it advances to process of step S360 (step S340).

At step S360, control unit 39 sends out the entered remote-control code to reproducing apparatus 10 side, and terminates the remote-control process (S360). That is, control unit 39, at step S300 and step S340, analyzes the remote-control code noticed from remote-control receiver 34. When the remote-control code is specified to be a remote-control code to reproducing apparatus 10 (reproduction side), control unit 39 sends out this remote-control code to reproducing apparatus 10 by way of the control data I/F unit 38 and control cable 58 at step S360. Control unit 19 of reproducing apparatus 10 receives the remote-control code, and executes process or control corresponding to the remote-control code. Thus, by manipulating only remote controller 40 for TV receiver 30, operation and setting on reproducing apparatus 10 can be also executed.

At step S342, control unit 39 judges if the entered remote-control code is a code for instructing menu screen display of TV receiver 30 side as shown in FIG. 2A or not. In the case of the code instructing menu screen display (Yes), it advances to process of step S344, or in the case of the code not instructing menu screen display (No), it advances to process of step S350 (step S342). At step S344, control unit 39 instructs drawing generation unit 36 to generate drawing data of menu screen, and instructs synthesis unit 35 to synthesize the drawing data generated by drawing generation unit 36, and thereby terminates the remote-control process (S344). Thus, the synthesized image of on-screen display of menu screen at TV receiver 30 side on the image by tuner unit 31 is shown on display 42.

At step S350, control unit 39 judges whether the menu screen of TV receiver side 30 side is being displayed or not. If being displayed (Yes), it advances to step S352, or if not being displayed (No), it advances to step S358 (step S350). At step S358, control unit 39 controls the operation of TV receiver 30 side corresponding to the entered remote-control code, such as selection of channel or change of sound volume, and thereby terminates the remote-control process (step S358).

At step S352, in this case, the menu screen at TV receiver 30 side is being displayed, and control unit 39 controls operation of the menu screen of TV receiver 30 side (step S352). That is, control unit 39 controls to execute the operation determined by correspondence of the entered remote-control code and its menu screen. For example, as shown in FIG. 2A, when the “Set menu” button is selected and then the remote-control code showing “Fix” is fixed, control unit 39 judges that the display of sub menu screen for setting the display format of menu screen has been instructed, and controls to display sub menu screen 361 as shown in FIG. 2A.

At step S354, control unit 39 judges whether the entered remote-control code is a code corresponding to the operation for setting the display format as shown in FIG. 2A to the menu screen at TV receiver 30 side or not. If judged to be the code corresponding to the operation for setting the display format (Yes), it advances to process of step S356, and if judged not to be the code corresponding to the operation for setting the display format (No), it terminates the remote-control process (step S354). At step S356, control unit 39 saves the display format information changed by operation for setting the display format, in the memory, as new display format information at TV receiver 30 side, that is, at the display side, and terminates the remote-control process (step S356).

In this explanation, at step S342, control unit 39 judges only whether or not the remote-control code instructing menu screen display at TV receiver 30 side, and depending on the judging result, the process at TV receiver 30 side is executed. However, for example, the following judging step may be included in the procedure. That is, together with the judging process at step S342, it is judged whether the contents data of TV receiver 30 side or reproducing apparatus 10 side has been chosen at changeover unit 32. When TV receiver 30 side is selected, the remote-control code corresponding to the menu screen of TV receiver 30 side is operated, and when reproducing apparatus 10 side is selected, this remote-control code is sent out to reproducing apparatus 10 by way of control cable 58 or the like. Thus, the process for controlling by control unit 39 may be included. Further, even when the contents data of reproducing apparatus 10 side is selected in changeover unit 32, and the menu screen of reproducing apparatus 10 side is being displayed, if it is focused to display the menu screen of TV receiver 30 side on the top, control unit 39 may contain a step of controlling to operate as the remote-control code corresponding to the menu screen of TV receiver 30 side.

At step S300, if the entered remote-control code is judged to be an input changeover code for instructing changeover between the contents data from tuner unit 31 and the contents data entered externally from reproducing apparatus 10 (Yes), control unit 39 processes as follows.

First, control unit 39 judges the changeover direction of this input changeover, whether changeover from TV receiver 30 side to reproducing apparatus 10 side (TV to reproduction), or changeover from reproducing apparatus 10 side to TV receiver 30 side (reproduction to TV) (step S320). When control unit 39 judges the input changeover is from TV receiver 30 side to reproducing apparatus 10 side (TV to reproduction), it advances to process of step S322. If the input changeover is judged to be from reproducing apparatus 10 side to TV receiver 30 side (reproduction to TV), it advances to process of step S332.

At step S322, control unit 39 changes over to the contents data supplied from reproducing apparatus 10, and controls to instruct the video and audio by the contents data (step S322). That is, control unit 39 instructs changeover unit 32 to select the contents data supplied from reproducing apparatus 10 to AV data I/F unit 37, and hence the contents data reproduced in reproducing apparatus 10 is presented from TV receiver 30. Control unit 39 further advances to process of step S324, and sends out the display format information of TV receiver 30 side, that is, the menu screen of the display side held in control unit 39 to control unit 19 of reproducing apparatus 10 side, and thereby terminates the remote-control process (step S324).

At step S332, control unit 39 changes over to the contents data supplied from tuner unit 31, and controls to present video and audio by the contents data (step S332). That is, control unit 39 instructs changeover unit 32 to select the contents data from tuner unit 31, and hence the contents received in tuner unit 31 are presented to TV receiver 30. Further, control unit 39 advances to process of step S334, and acquires the display format information at reproducing apparatus 10 side held in control unit 19 of reproducing apparatus 10, that is, the reproduction side menu screen, and terminates the remote-control process (step S334).

In reproducing apparatus 10, the menu process executed by control unit 19 is explained while referring to FIG. 4.

First, as explained at step S360 in FIG. 3, when the remote-control code relating to reproducing apparatus 10 side to TV receiver 30 is noticed to control unit 39, this remote-control code is sent out to control unit 19 of reproducing apparatus 10 by way of control data I/F unit 38 and control cable 58. In FIG. 4, as the remote-control code to be sent out to control unit 19, an example is shown to send out a remote-control code including the remote-control code of input changeover in TV receiver 30.

As shown in FIG. 4, control unit 19 of reproducing apparatus 10 receives a remote-control code from control unit 39 of TV receiver 30, and judges the received remote-control code. That is, control unit 19 judges whether the remote-control code is a code showing input changeover or not, and in the case of input changeover code (Yes), the process including the process of noticing such display format information is executed. Control unit 19, if judging the remote-control code is not input changeover code (No), advances to process of step S142. In the case of input changeover code (Yes), it advances to process of step S120 (step S100).

At step S142, the control unit 19 judges whether the entered remote-control code is a code for instructing menu screen display of reproducing apparatus 10 side as shown in FIG. 2B or not. In the case of code for instructing menu screen display (Yes), it advances to process of step S144, and in the case of code not for instructing menu screen display (No), it advances to process of step S150 (step S142). At step S144, control unit 19 instructs drawing generation unit 16 to generate the drawing data of menu screen, and instructs synthesis unit 15 to synthesize the drawing data generated by drawing generation unit 16, and thereby terminates the remote-control process (step S144). Thus, the drawing data of the menu screen of reproducing apparatus 10 side is synthesized to the video data reproduced in reproducing unit 11, and the synthesized video data is generated.

At step S150, control unit 19 judges whether the menu screen of reproducing apparatus 10 side is being displayed or not. If being displayed (Yes), it advances to process of step S152. If not being displayed (No), it advances to process of step S158 (step S150). At step S158, control unit 19 controls to operate reproducing apparatus 10 side according to the noticed remote-control code, and terminates the remote-control process (S158).

At step S152, in this case, since the menu screen of reproducing apparatus 10 side is being displayed on display 42 of TV receiver 30, control unit 19 controls to operate the menu screen of reproducing apparatus 10 side (step S152). That is, control unit 19 controls to execute the operation related by the noticed remote-control code and the menu screen. For example, as shown in FIG. 2B, when the “Set menu” button is selected and then the “Fix” remote-control code is noticed, control unit 19 judges that the display of sub menu screen for setting the display format has been instructed, ad controls to display sub menu screen 161 as shown in FIG. 2B.

At step S154, control unit 19 judges whether the entered remote-control code is a code corresponding to the operation for setting the display format as shown in FIG. 2B to the menu screen of reproducing apparatus 10 side or not. In the case of the code corresponding to operation for setting the display format (Yes), it advances to step S156. In the case of the code not corresponding to operation for setting the display format (No), it terminates the remote-control process (step S154). At step S156, control unit 19 saves the display format information changed by operation for setting the display format in the memory as new display format information at reproducing apparatus 10 side, that is, as new reproduction side menu screen, and terminates the remote-control process (step S156).

Next, at step S100, when the noticed remote-control code is judged to be input changeover code (Yes), control unit 19 processes as follows.

First, control unit 19 judges the changeover direction of this input changeover, whether changeover from TV receiver 30 side to reproducing apparatus 10 side, or changeover from reproducing apparatus 10 side to TV receiver 30 side (step S120). When control unit 19 judges the input changeover is from TV receiver 30 side to reproducing apparatus 10 side (TV to reproduction), it advances to process of step S122. If the input changeover is judged to be from reproducing apparatus 10 side to TV receiver 30 side (reproduction to TV), it advances to process of step S132.

At step S122, control unit 19 controls to instruct reproduction unit 11 to start reproduction, or to instruct drawing generation unit 16 to generate drawing data to inform the use of completion of preparation for reproduction (step S122). Control unit 19 further advances to process of step S124, and acquires the display format information at TV receiver 30 side held in control unit 39 of TV receiver 30, that is, the display side menu screen, and thereby terminates the remote-control process (step S124).

At step S132, control unit 19 controls to instruct reproduction unit 11 to stop reproduction (step S132). Control unit 19 advances to process of step S134, and sends out the display format information at reproducing apparatus 10 side held in control unit 19, that is, the reproduction side menu screen to control unit 39 of TV receiver side 30, and terminates the remote-control process (step S134).

The audio-visual system, the reproducing apparatus, and the display device of the preferred embodiment execute as above in response to the user's operation of remote-control operation or menu screen operation. In particular, the audio-visual system, the reproducing apparatus, and the display device of the preferred embodiment exchange display format information between TV receiver 30 and reproducing apparatus 10 as shown in FIG. 3 and FIG. 4, depending on the user's operation of input changeover by remote controller 40.

That is, when the input changeover is the changeover from TV receiver 30 side to reproducing apparatus 10 side, control unit 39 of TV receiver 39 sends out the display format information of TV receiver 30 side held in control unit 39 to control unit 19 of reproducing apparatus 10 side as shown at step S324 in FIG. 3. At the same time, as shown in step S124 in FIG. 4, control unit 19 of reproducing apparatus 10 side acquires the display format information sent out from control unit 39. By execution of such process, the display format of the menu screen by TV receiver 30 is reflected in the display format of the menu screen by reproducing apparatus 10.

To the contrary, when the input changeover is the changeover from reproducing apparatus 10 side to TV receiver 30 side, control unit 19 of reproducing apparatus 10 sends out the display format information of reproducing apparatus 10 side held in control unit 19 to control unit 39 of TV receiver 30 side as shown at step S134 in FIG. 4. At the same time, as shown in step S334 in FIG. 3, control unit 39 of TV receiver 30 side acquires the display format information sent out from control unit 19. By execution of such process, the display format of the menu screen by reproducing apparatus 10 is reflected in the display format of the menu screen by TV receiver 30.

The menu screens specified by various display formats of the audio-visual system, the reproducing apparatus, and the display device are explained below by showing specific examples.

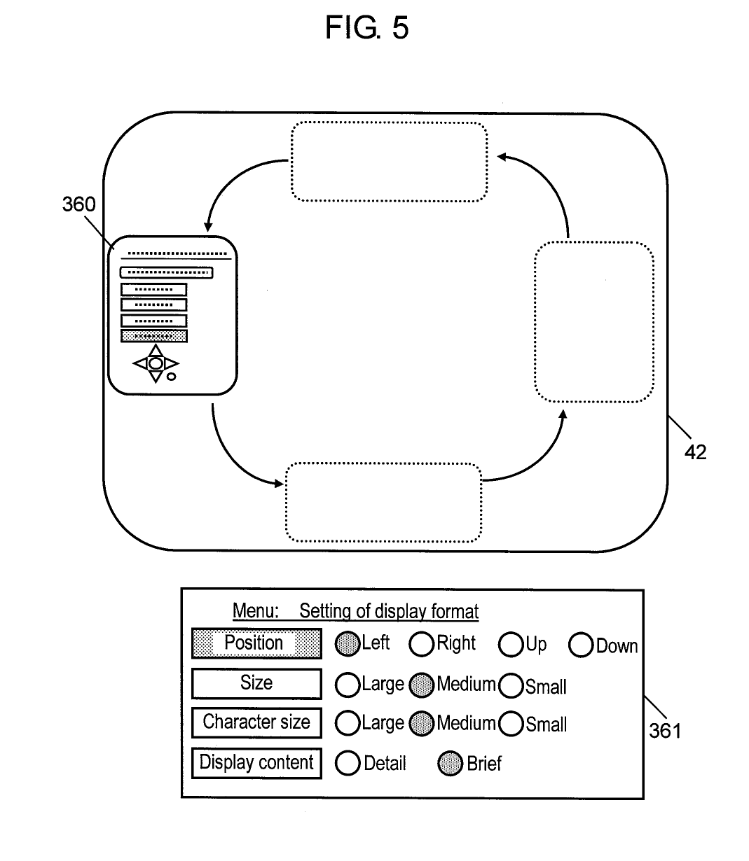

FIG. 5 is a diagram showing an example of display according to a display format about the position of menu screen. In the sub menu screen 361 shown in FIG. 5, it is supposed that the user selects the “Position” button for setting the display position of menu screen, further selects any one of “Left”, “Right”, “Up” and “Down” buttons, and finally presses the “Fix” button of remote controller 40. After this setting, the menu screen is shown at the specified position on display 42. In FIG. 5, the “Left” button is selected, and main menu screen 360 is shown at the left side of display 42 as shown in FIG. 5. By setting the display position of the menu screen in such a manner, the menu screen is shown at a position easily visible for the user. For example, when displaying at right side or left side on display 42, the menu screen may be shown vertically long, or when displaying at upper side or lower side on display 42, the menu screen may be shown horizontally long, and the concealed portion of the image on display may be minimized.

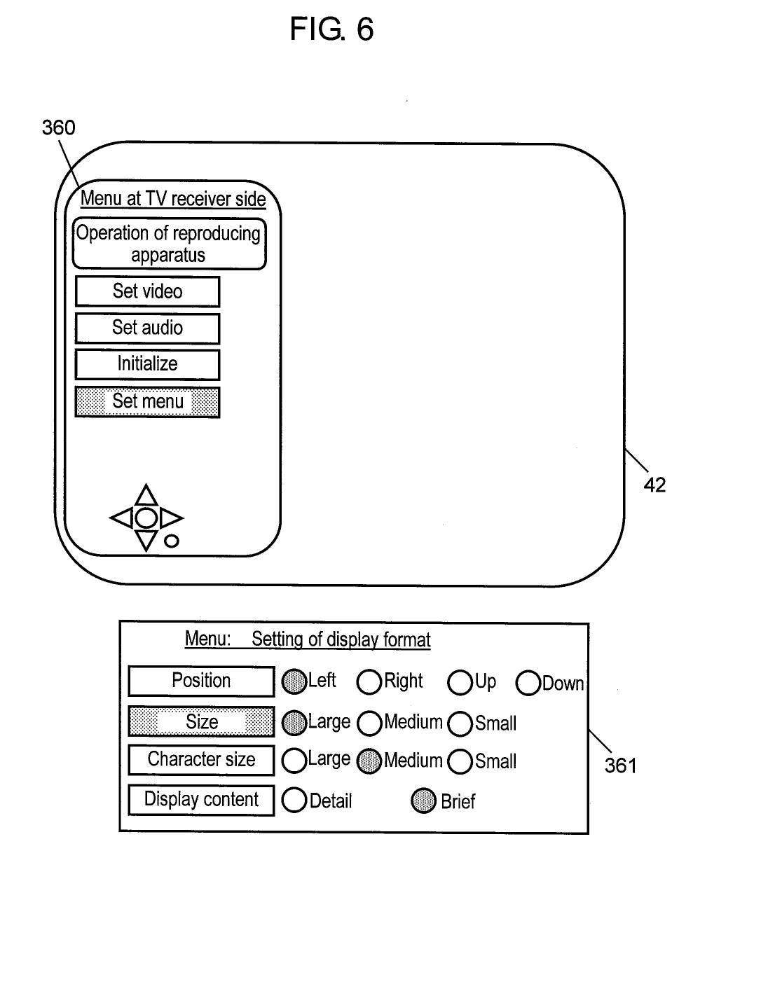

FIG. 6 is a diagram showing an example of display according to a display format about the size of menu screen. In sub menu screen 361 shown in FIG. 6, it is supposed that the user selects the “Size” button for setting the size of menu screen, further selects any one of “Large”, “Medium” and “Small” buttons, and finally presses the “Fix” button of remote controller 40. After this setting, the menu screen is shown in the specified size on display 42. In FIG. 6, the “Large” button is selected, and main menu screen 360 is shown in a large size as shown in FIG. 6. By setting the size of the menu screen in such a manner, the menu screen is shown in a size easily visible for the user.

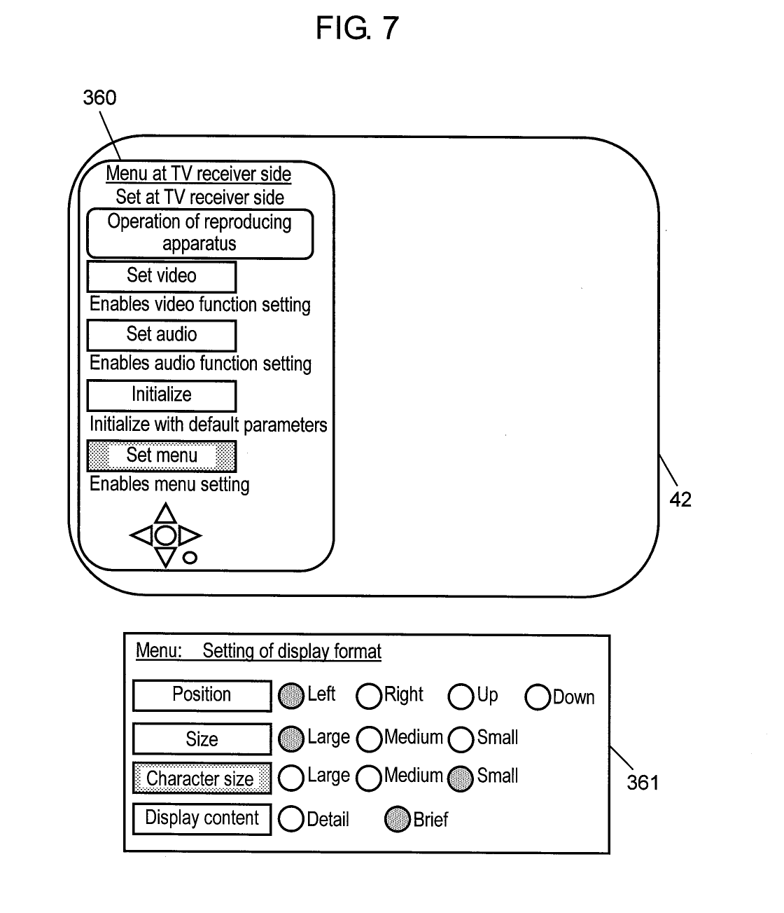

FIG. 7 is a diagram showing an example of display according to a display format about the character size of menu screen. In sub menu screen 361 shown in FIG. 7, it is supposed that the user selects the “Character size” button for setting the character size of menu screen, further selects any one of “Large”, “Medium” and “Small” buttons, and finally presses the “Fix” button of remote controller 40. After this setting, the menu screen is shown in the specified character size on display 42. In FIG. 7, the “Small” button is selected, and main menu screen 360 is shown in a small character size as shown in FIG. 7. By setting the character size of the menu screen in a small size, a brief explanation is added in a vacant space. Thus, by setting the character size of menu screen as desired for the user, the menu screen is shown in a proper character size for the user. If the user prefers a detailed content display, more information can be shown in a small character size, and the explanatory comment may be added or omitted depending on the character size.

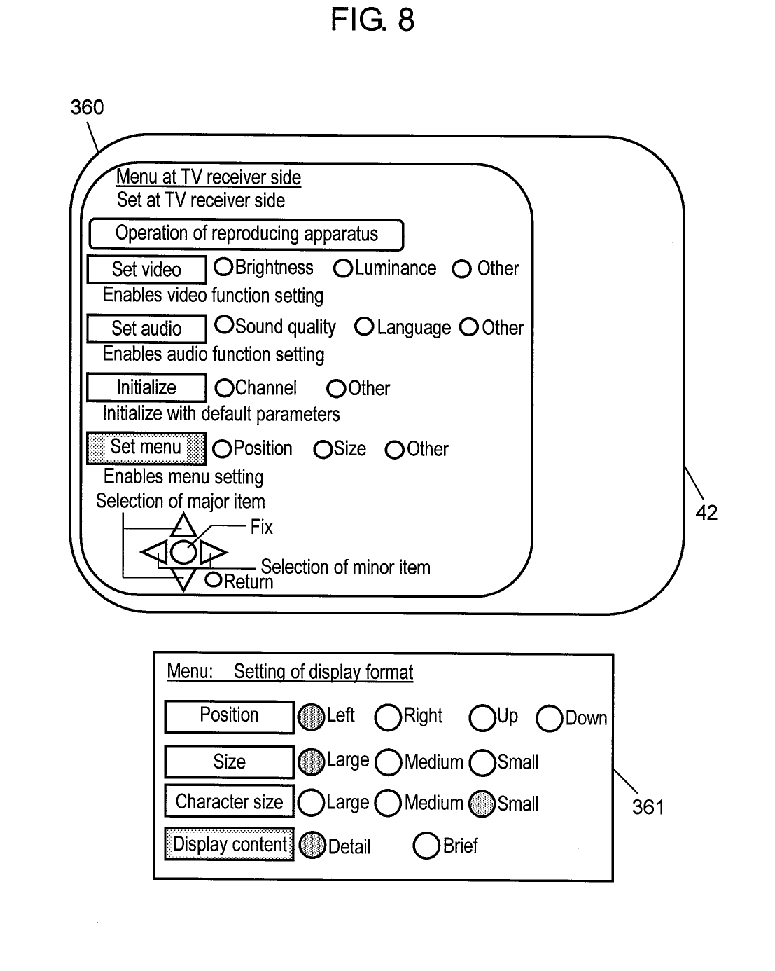

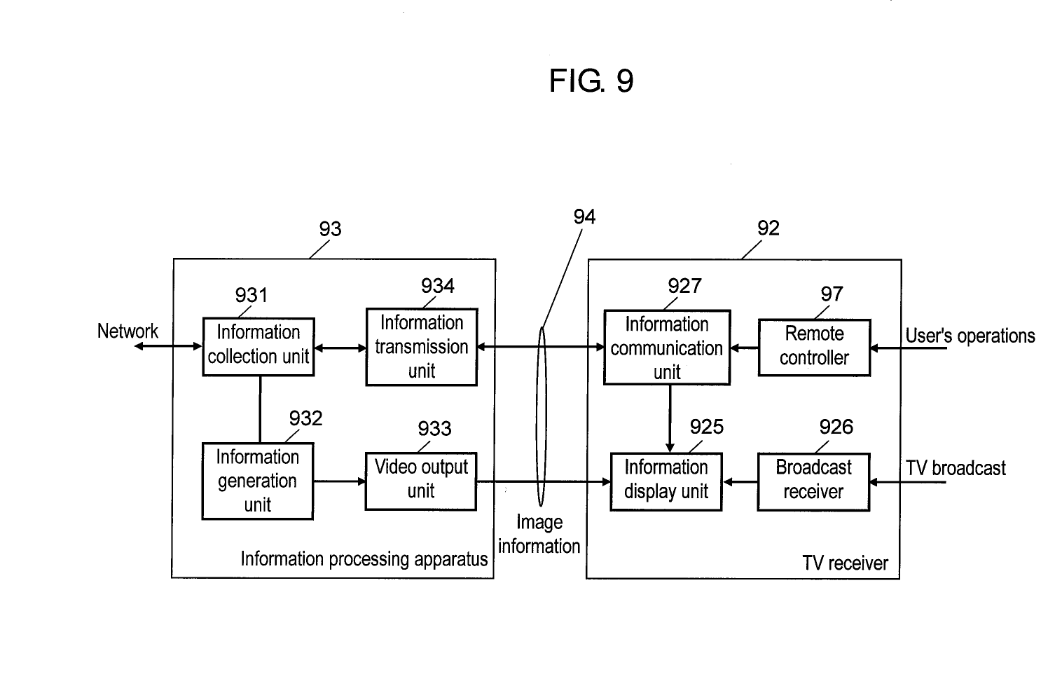

FIG. 8 is a diagram showing an example of display according to a display format about the display content of menu screen. In sub menu screen 361 shown in FIG. 8, it is supposed that the user selects the “Display content” button for setting the detail of display content of menu screen, further selects either one of “Detail” and “Brief” buttons, and finally presses the “Fix” button of remote controller 40. After this setting, the menu screen is shown in the specified detailing of display content on display 42. In FIG. 8, the “Detail” button is selected, and main menu screen 360 is shown in a specified detail as shown in FIG. 8. By setting the detail of the display content, the menu screen can be displayed according to the knowledge of the user.

In FIG. 5 to FIG. 8, setting of main menu screen 360 is explained, but sub menu screen 361 may be set similarly. Also in FIG. 5 to FIG. 8, examples of the menu screen generated in drawing generation unit 36 of TV receiver 30 are shown, but the menu screen of drawing generation unit 16 of reproducing apparatus 10 may be similarly generated as desired.

As shown in FIG. 5 to FIG. 8, the audio-visual system, the reproducing apparatus, and the display device are designed to be vary the display format of the menu screen as desired, and the menu screen suited to the preference of the user may be presented. In particular, in addition to the display position and size of the menu screen, the character size and detail of display content can be also varied, and the menu screen further suited to the preference of the user may be realized. As mentioned above, moreover, in the audio-visual system, the reproducing apparatus, and the display device, the display format information for setting the display format of the menu screen can be held individually in TV receiver 30 and reproducing apparatus 10, and the changed display format information is mutually exchanged. Therefore, the display format specified in the menu screen of either TV receiver 30 or reproducing apparatus 10 is mutually reflected, and the menu screen suited to the preference of the user is displayed regardless of the contents selection at TV receiver 30 side or at reproducing apparatus 10 side.

As explained herein, the audio-visual system in the preferred embodiment of the present invention is an audio-visual system including TV receiver 30 for on-screen display of drawn picture in a specified display format, and reproducing apparatus 10 for supplying the data including the contents data of the contents to be reproduced to TV receiver 30, which are interconnected by way of control cable 50. TV receiver 30 has display side drawing generation unit 36 for generating display side drawing data of drawn picture according to the display format of on-screen display, and reproducing apparatus 10 has reproduction side drawing generation unit 16 for generating reproduction side drawing data of drawn picture conforming to the display format of display in TV receiver 30. Reproduction side drawing generation unit 16 receives the display side display format information of drawing generation unit 36 through connection cable 50, and generates the reproduction side drawing data in the display format based on the received display side display format information. Reproducing apparatus 10 supplies the contents data including the generated reproduction side drawing data to TV receiver 30 through connection cable 50, and TV receiver 30 presents the drawn picture on the basis of the supplied reproduction side drawing data. Display side drawing generation unit 36 receives the reproduction side display format information of drawing generation unit 16 through connection cable 50, and generates the display side drawing data in the display format based on the received reproduction side display format information. TV receiver 30 presents the drawn picture on the basis of the generated display side drawing data.

The audio-visual system, the reproducing apparatus, and the display device in the preferred embodiment of the present invention have such configuration, and therefore in generation of drawn picture such as menu screen, reproduction side drawing generation unit 16 generates drawing data in display format based on the display format of display side drawing generation unit 36. Display side drawing generation unit 36 generates the drawing data in display format based on the display format of reproduction side drawing generation unit 16. Accordingly, between TV receiver 30 of display side and reproducing apparatus 10 of reproduction side, the position, shape and size of drawn picture can be adjusted commonly, and the menu screen easily recognized by the user can be presented, and the audio-visual system, the reproducing apparatus, and the display device enhanced in convenience of operation for the user can be presented.

In the present invention, by using only the remote controller of the TV receiver, the reproducing apparatus and other external devices an be controlled, and the menu screen suited to the visual recognition of the user can be set commonly without having to set individually in each device. Hence, the present invention can be applied, for example, in the audio-visual system, the reproducing apparatus, and the display device, composed of the TV receiver and the display device, and other appliances connected thereto, such as the reproducing apparatus, recording and reproducing apparatus, camera device, personal computer, audio appliance, and others.

What is claimed is:

1. An audio-visual system comprising:
a display device for on-screen display of a drawn picture in a specified display format,
a reproducing apparatus for supplying data, which include contents data to be reproduced, to the display device; and
the display device and the reproducing apparatus being connected by way of communication means,
wherein the display device has a display side drawing generation unit for generating display side drawing data of the drawn picture according to the display format of the on-screen display,
wherein the reproducing apparatus has a reproduction side drawing generation unit for generating reproduction side drawing data of the drawn picture according to the display format for displaying on the display device,
wherein the reproduction side drawing generation unit receives the display side display format information as the information of the display format of the display side drawing generation unit by way of communication means, and
generates the reproduction side drawing data based on the received display format information of the display side,
wherein the reproducing apparatus supplies the contents data including the generated reproduction side drawing data to the display device by way of communication means,
wherein the display device presents the drawn picture based on the supplied reproduction side drawing data.

2. The audio-visual system of claim 1,
wherein the display side drawing generation unit receives the reproduction side display format information as the information of the display format by way of communication means, and
generates the display side drawing data based on the received display format information of the reproduction side,
wherein the display device presents the drawn picture based on the generated display side drawing data.

3. The audio-visual system of claim 1,
wherein the display device has a function of receiving a remote-control signal from a remote controller, and judging whether the received remote-control signal is for an operation on the display device or on the reproducing apparatus,
wherein when the remote-control signal is judged to be for the operation on the reproducing apparatus, the display device notices the instruction information of the received remote-control signal including instruction information as generation instruction of the reproduction side drawing data on the reproduction side drawing generation unit to the reproducing apparatus by way of the communication means,
wherein the reproducing apparatus executes a process according to the instruction information noticed by way of the communication means.

4. The audio-visual system of claim 2,
wherein the display device has a function of receiving a remote-control signal from a remote controller, and judging whether the received remote-control signal is for an operation on the display device or on the reproducing apparatus,
wherein when the remote-control signal is judged to be for the operation on the reproducing apparatus, the display device notices the instruction information of the received remote-control signal including the instruction information as generation instruction of the reproduction side drawing data on the reproduction side drawing generation unit to the reproducing apparatus by way of the communication means,
wherein the reproducing apparatus executes a process according to the instruction information noticed by way of the communication means.

5. The audio-visual system of claim 3,
wherein the display format information includes at least one of the following:
information of a position of on-screen display of the drawn picture,
information of a size of the drawn picture,
information of a character size displayed on the drawn picture, and
information of detailing of contents displayed on the drawn picture.

6. The audio-visual system of claim 4,
wherein the display format information includes at least one of the following:
information of a position of on-screen display of the drawn picture,
information of a size of the drawn picture,
information of a character size displayed on the drawn picture, and
information of detailing of contents displayed on the drawn picture.

7. The audio-visual system of claim 5,
wherein the drawn picture includes a picture of a menu screen for setting selectively a function of a corresponding device.

8. The audio-visual system of claim 6,
wherein the drawn picture includes a picture of a menu screen for setting selectively a function of a corresponding device.

9. A reproducing apparatus, which is connected to a display device for on-screen display of a drawn picture in a specified display format and supplies data including contents data to be reproduced to the display device, comprising:
a reproduction side drawing generation unit for receiving display side display format information as information of the display format of the display device, and generating reproduction side drawing data of the display format based on the received display side display format information, and
a data supply unit for supplying the reproduction side drawing data to the display device together with the contents data.

10. A display device connected to a reproducing apparatus for supplying a data including contents data to be reproduced, for on-screen display of a drawn picture in a specified display format, comprising:
a display side drawing generation unit for receiving reproduction side display format information as the information of the display format of drawn picture of the reproducing apparatus, and generating display side drawing data of the display format based on the received reproduction side display format information.

11. The display device of claim 10, further comprising:
a remote-control receiver for receiving a remote-control signal from a remote controller, and
a control unit,
wherein the control unit judges whether the remote-control signal is for an operation on the display device or on the reproducing apparatus, and
wherein when the remote-control signal is judged to be a remote-control signal for the operation on the reproducing apparatus, the control unit notices information of the display format of the drawn picture on the reproducing apparatus to the reproducing apparatus by way of the communication means as reproduction side display format information.
